(19) United States
(12) Patent Application Publication
(10) Pub. No.: US 2024/0289271 A1
(43) Pub. Date: Aug. 29, 2024

(54) Data Storage Devices with Services to Manage File Storage Locations

(71) Applicant: Micron Technology, Inc., Boise, ID (US)

(72) Inventor: Luca Bert, San Jose, CA (US)

(21) Appl. No.: 18/439,696

(22) Filed: Feb. 12, 2024

Related U.S. Application Data
(60) Provisional application No. 63/487,143, filed on Feb. 27, 2023.

(51) Int. Cl. G06F 12/02; G06F 12/06; G06F 13/42

(52) U.S. Cl. CPC G06F 12/0246; G06F 12/063; G06F 13/4221

(57) ABSTRACT

Memory sub-systems configured to manage storage locations of files for a host system. For example, a connection from a memory sub-system to the host system can support both a cache-coherent memory access protocol to a memory device implemented in the storage capacity of the memory sub-system and a storage access protocol. The memory sub-system can maintain, and share with the host system via the memory device, a medium map configured to identify, for a file stored in the memory sub-system, memory addresses usable for the host system to access locations in the file over the connection using the cache-coherent memory access protocol, and/or logical block addresses usable for the host system to access blocks of the files over the connection using the storage access protocol.

### RELATED APPLICATIONS

The present application claims priority to Prov. U.S. Pat. App. Ser. No. 63/487,143 filed Feb. 27, 2023, the entire disclosures of which application are hereby incorporated herein by reference.

### TECHNICAL FIELD

At least some embodiments disclosed herein relate to memory systems in general, and more particularly, but not limited to memory systems configured to be accessible for memory services and storage services.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a memory sub-system in accordance with some embodiments of the present disclosure.

FIG. 2 shows a memory sub-system configured to offer both memory services and storage services to a host system over a physical connection according to one embodiment.

FIG. 3 shows a memory sub-system configured to provide memory services using a portion of the non-volatile storage capacity of the memory sub-system according to one embodiment.

FIG. 4 illustrates operations configured in a memory sub-system to respond to a memory access request according to one embodiment.

FIG. 5 illustrates a configuration to allow a portion of the non-volatile storage capacity of the memory sub-system to be addressable via both memory services and storage services according to one embodiment.

FIG. 6 shows a technique of file storage management in a computing system according to one embodiment.

FIG. 7 shows a memory sub-system configured to manage storage locations of in-memory files according to one embodiment.

FIG. 8 shows the storage management of an in-memory file system that is partially in a memory sub-system and partially in the memory of a host system according to one embodiment.

FIG. 9 shows the storage management of files that are accessible both via a cache-coherent memory access protocol and via a storage access protocol according to one embodiment.

FIG. 10 shows a method to manage file storage locations using a memory sub-system according to one embodiment.

### DETAILED DESCRIPTION

At least some aspects of the present disclosure are directed to techniques of a memory sub-system providing memory services and storage services over a physical connection to a host system. The memory sub-system can be configured to allocate a portion of its fast, volatile random access memory, and optionally a portion of its non-volatile memory, to implement a memory device attached by the memory sub-system to the host system over the connection. The host system can mount a file system on the memory sub-system. The host system and the memory sub-system can cooperate with each other via the memory device in managing the storage locations of files in the file system mounted on the memory sub-system.

For example, a host system and a memory sub-system (e.g., a solid-state drive (SSD)) can be connected via a physical connection according to a computer component interconnect standard of compute express link (CXL). Compute express link (CXL) includes protocols for storage access (e.g., cxl.io), and protocols for cache-coherent memory access (e.g., cxl.mem and cxl.cache). Thus, a memory sub-system can be configured to provide both storage services and memory services to the host system over the physical connection using compute express link (CXL).

A typical solid-state drive (SSD) is configured or designed as a non-volatile storage device that preserves the entire set of data received from a host system in an event of unexpected power failure. The solid-state drive can have volatile memory (e.g., SRAM or DRAM) used as a buffer in processing storage access messages received from a host system (e.g., read commands, write commands). To prevent data loss in a power failure event, the solid-state drive is typically configured with an internal backup power source such that, in the event of power failure, the solid-state drive can continue operations for a limited period of time to save the data, buffered in the volatile memory (e.g., SRAM or DRAM), into non-volatile memory (e.g., NAND). When the limited period of time is sufficient to guarantee the preservation of the data in the volatile memory (e.g., SRAM or DRAM) during a power failure event, the volatile memory as backed by the backup power source can be considered non-volatile from the point of view of the host system. Typical implementations of the backup power source (e.g., capacitors, battery packs) limit the amount of volatile memory (e.g., SRAM or DRAM) configured in the solid-state drive to preserve the non-volatile characteristics of the solid-state drive as a data storage device. When functions of such volatile memory are implemented via fast non-volatile memory, the backup power source can be eliminated from the solid-state drive.

When a solid-state drive is configured with a host interface that supports the protocols of compute express link, a portion of the fast, volatile memory of the solid-state drive can be optionally configured to provide cache-coherent memory services to the host system. Such memory services can be accessible via load/store instructions executed in the host system at a byte level (e.g., 64B or 128B) over the connection of computer express link. Another portion of the volatile memory of the solid-state drive can be reserved for internal use by the solid-state drive as a buffer memory to facilitate storage services to the host system. Such storage services can be accessible via read/write commands provided by the host system at a logical block level (e.g., 4 KB) over the connection of computer express link.

When such a solid-state drive (SSD) is connected via a computer express link connection to a host system, the solid-state drive can be attached and used both as a memory device and a storage device to the host system. The storage device provides a storage capacity addressable by the host system via read commands and write commands at a block level for data records of a database; and the memory device provides a physical memory addressable by the host system via load instructions and store instructions at a byte level.

A solid-state drive can have a small amount of volatile memory (e.g., DRAM or SRAM) and a large amount of non-volatile memory (e.g., NAND). The volatile memory is faster than the non-volatile memory. A portion of the volatile memory and a portion of the non-volatile memory can be used to implement a memory device accessible to a host system via a computer express link (CXL) connection. The memory device provided by the solid-state drive can have an addressable memory space larger than what can be implemented via the volatile memory of the solid-state drive.

The memory device provided by the solid-state drive can be configured to have some pages of the memory space present in the volatile memory and thus addressable via physical memory addresses in the portion of the volatile memory allocated to the memory device. The remaining pages of the memory space can be swapped out to the non-volatile memory.

When a memory access request (e.g., resulting from execution of a load instruction or a store instruction) is addressed to a page that is not currently present in the volatile memory, a paging system of the solid-state drive can pull the content of the page from the non-volatile memory into the volatile memory. For example, the solid-state drive can allocate a page from the volatile memory, retrieve from the non-volatile memory the content of the page being accessed, and store the content in the allocated page.

When a memory access request is configured to load data from the page of the memory space provided by the memory device, the solid-state drive can service the request using the data from the corresponding physical addresses of memory cells in the allocated page.

When a memory access request is configured to store data into the page of the memory space provided by the memory device, the solid-state drive can service the request by storing the data to memory cells at the corresponding physical addresses in the page allocated from the volatile memory. If the memory access request causes a page to be allocated from the volatile memory to represent the page of the memory space being accessed, the storing of the data can be performed in parallel with retrieving the content of the page from the non-volatile memory. After the retrieval of the content of the page from the non-volatile memory, the portion of the content outside of the physical addresses updated by the memory access request can be stored into memory cells in the allocated page, without storing the corresponding portion that has been updated via the memory access request. Alternatively, the data of the memory access request can be buffered for combination with the page content pulled from the non-volatile memory before storing the modified page content into the allocated page of volatile memory.

The solid-state drive can be configured to write contents of pages in the volatile memory into corresponding pages of the memory space in the non-volatile memory periodically, or when power fails, or when a page of the volatile memory is to be reallocated for the active memory operations of another page in the memory space.

For example, when the portion of the volatile memory allocated to the memory device is full (e.g., having been assigned to represent some pages of the memory space hosted in the non-volatile memory), the solid-state drive can select a page for swapping back into the non-volatile memory when the host system requests to access a further page of the memory space that has not yet been pulled into the volatile memory. For example, the solid-state drive can select a least recently used (LRU) page and write the selected page from the volatile memory to the non-volatile memory. Alternatively, another page replacement technique, such as first in first out (FIFO), optimal page replacement, etc., can be used.

Optionally, the paging system of the solid-state drive can be configured to save, proactively in the background, a page that may be selected for swapping output according to a page replacement technique. For example, while the host system is accessing some of the pages that have been pulled into the volatile memory, the paging system can select a page as a candidate for swapping out and write the page to the non-volatile memory, if the selected page has changes that render the corresponding page in the non-volatile memory out of date. Once the page in the volatile memory and the corresponding page in the non-volatile memory have the same content, the page in the volatile memory is clean and ready for reuse. When the host system requests access to another page that has not yet been pulled into the volatile memory, a clean page can be allocated immediately to represent the accessed page, since the content in the clean page can be erased immediately without a need to save the content. As a result, the delay in responding to the memory request can be reduced or minimized.

Optionally, a portion of the non-volatile memory allocated to implement the memory device is also configured to be accessible as part of the storage device. Thus, the host system can have the option to access data in the portion of the non-volatile memory via a memory access protocol and the option to access the data via a storage access protocol. For example, the memory space of the memory device can be accessed via logical block addresses in a namespace of storage space in the solid-state drive using a storage access protocol, and accessed via memory addresses in the memory space implemented by the memory device using a cache-coherent memory access protocol.

Optionally, the host system can send a configuration request to the solid-state drive to customize the memory services provided by the solid-state drive over the computer express link connection. For example, the configuration request can identify the allocation of resources to implement the memory device, such as a size of the memory space provided by the memory device, the amount of volatile memory allocated to present pages of the memory space, the amount of non-volatile memory allocated to host pages of the memory space, the range of memory addresses for accessing the memory space, a namespace of storage space for accessing the data in the memory space via a storage access protocol, etc.

When the host system mounts a file system in the solid-state drive, a file system manager running in the host system can control various aspects of the file system, such as file names, directory organization, access attributes, security, etc. The structure and access control features of the file system can be used to facilitate collaborations across processes and systems.

In a typical computer system, the file system manager running in the host system is configured to manage the storage locations of file contents. As a result, the solid-state drive in which the files are stored may not be aware of certain operations in the file system that can free up storage resources for reuse. To reduce inefficiencies, the host system can be configured to send commands to the solid-state drive to discard (e.g., in Linux), deallocate (e.g., in NVMe), or trim (e.g., in SATA) the allocations of storage resources that are previously used to store file contents and that are no longer used by the file system. Using such commands to free up storage resources that are no longer in use can be clumsy and can have severe performance impacts.

It is advantageous to use the solid-state drive to manage the storage locations of files stored in the solid-state drive. When the solid-state drive is configured to manage the file storage locations, the solid-state drive is fully aware of which storage locations are in use in the file system and which storage locations are no longer in use in the file system. Thus, the solid-state drive can reclaim the storage resources that are no longer in use. The operations of reclaiming the storage resources freed from the file system can be implemented the solid-state drive in connection with other background operations, such as erasing, wear leveling, garbage collection, etc., for improved and more stable performance.

The file system manager running in the host system can manage the storage locations of files stored outside of the solid-state drive.

There are advantages in performing mapping of file storage locations in the solid-state drive. The solid-state drive knows its resources better than the file system manager running in the host system. Thus, the solid-state drive can perform the mapping more efficiently than the host system. The solid-state drive can be configured to perform both logical address mapping and physical address mapping for improved efficiency and for offloading inefficient operations from the host system.

When the solid-state drive attaches a portion of its memory resources as a memory device to the host system, the file system manager running in the host system and the solid-state drive can coordinate with each other via the memory device to offload, to the solid-state drive, the task of storage management for files stored in the solid-state drive.

For example, a message queue can be configured in the memory device for the file system manager running in the host system to request allocations of the storage resources for a file, change the allocations of storage resources for the file, request for identifications of storage resources of the file, etc. The solid-state drive can use the message queue in providing responses to requests from the host system, identifying of storage locations of the file, etc.

Optionally, the file system can be mounted at least in part on the memory device attached by the solid-state drive to the host system over the computer express link (CXL) connection. For example, the host system can use the memory space provided by the memory device to implement an in-memory file system. The solid-state drive can provide the services of mapping between memory addresses in the memory space and logical block addresses used in the file system to access corresponding locations in the memory device. When a portion of the memory device is implemented using the non-volatile memory, the solid-state drive can use a portion of its fast memory as a cache memory for the host system accessing the portion of the memory device.

Optionally, the host system and the solid-state drive can be configured to use the memory device to share the storage location data for files stored in the solid-state drive.

Optionally, when a file stored in the solid-state drive is accessible via both the cache-coherent memory access protocol and the storage access protocol, the solid-state drive can provide storage locations of the file in both memory addresses used in the cache-coherent memory access protocol and logical block addresses used in the storage access protocol.

It is advantageous for a host system to use a communication protocol to query the solid-state drive about the memory attachment capabilities of the solid-state drive, such as whether the solid-state drive can provide cache-coherent memory services, what is the amount of memory that the solid-state drive can attach to the host system in providing memory services, how much of the memory attachable to provide the memory services can be considered non-volatile (e.g., implemented via non-volatile memory, or backed with a backup power source), what is the access time of the memory that can be allocated by the solid-state drive to the memory services, etc.

The query result can be used to configure the allocation of memory in the solid-state drive to provide cache-coherent memory services. For example, a portion of fast memory of the solid-state drive can be provided to the host system for cache-coherent memory accesses; and the remaining portion of the fast memory can be reserved by the solid-state drive for internal. The partitioning of the fast memory of the solid-state drive for different services can be configured to balance the benefit of memory services offered by the solid-state drive to the host system and the performance of storage services implemented by the solid-state drive for the host system. Optionally, the host system can explicitly request the solid-state drive to carve out a requested portion of its fast, volatile memory as memory accessible over a connection, by the host system using a cache-coherent memory access protocol according to computer express link.

For example, when the solid-state drive is connected to the host system to provide storage services over a connection of computer express link, the host system can send a command to the solid-state drive to query the memory attachment capabilities of the solid-state drive.

For example, the command to query memory attachment capabilities can be configured with a command identifier that is different from a read command; and in response, the solid-state drive is configured to provide a response indicating whether the solid-state drive is capable of operating as a memory device to provide memory services accessible via load instructions and store instructions. Further, the response can be configured to identify an amount of available memory that can be allocated and attached as the memory device accessible over the computer express link connection. Optionally, the response can be further configured to include an identification of an amount of available memory that can be considered non-volatile by the host system and be used by the host system as the memory device. The non-volatile portion of the memory device attached by the solid-state drive can be implemented via non-volatile memory, or volatile memory supported by a backup power source and the non-volatile storage capacity of the solid-state drive.

Optionally, the solid-state drive can be configured with more volatile memory than an amount backed by its backup power source. Upon disruption in the power supply to the solid-state drive, the backup power source is sufficient to store data from a portion of the volatile memory of the solid-state drive to its storage capacity, but insufficient to preserve the entire data in the volatile memory to its storage capacity. Thus, the response to the memory attachment capability query can include an indication of the ratio of volatile to non-volatile portions of the memory that can be allocated by the solid-state drive to the memory services. Optionally, the response can further include an identification of access time of the memory that can be allocated by the solid-state drive to cache-coherent memory services. For example, when the host system requests data via a cache-coherent protocol over the compute express link from the solid-state drive, the solid-state drive can provide the data in a time period that is not longer than the access time.

Optionally, a pre-configured response to such a query can be stored at a predetermined location in the storage device attached by the solid-state drive to the host system. For example, the predetermined location can be at a predetermined logical block address in a predetermined namespace. For example, the pre-configured response can be configured as part of the firmware of the solid-state drive. The host system can use a read command to retrieve the response from the predetermined location.

Optionally, when the solid-state drive has the capability of functioning as a memory device, the solid-state drive can automatically allocate a predetermined amount of its fast, volatile memory as a memory device attached over the computer express link connection to the host system. The predetermined amount can be a minimum or default amount as configured in a manufacturing facility of solid-state drives, or an amount as specified by configuration data stored in the solid-state drive. Subsequently, the memory attachment capability query can be optionally implemented in the command set of the protocol for cache-coherent memory access (instead of the command set of the protocol for storage access); and the host system can use the query to retrieve parameters specifying the memory attachment capabilities of the solid-state drive. For example, the solid-state drive can place the parameters into the memory device at predetermined memory addresses; and the host can retrieve the parameters by executing load commands with the corresponding memory addresses.

It is advantageous for a host system to customize aspects of the memory services of the memory sub-system (e.g., a solid-state drive) for the patterns of memory and storage usages of the host system.

For example, the host system can specify a size of the memory device offered by the solid-state drive for attachment to the host system, such that a set of physical memory addresses configured according to the size can be addressable via execution of load/storage instructions in the processing device(s) of the host system.

Optionally, the host system can specify the requirements on time to access the memory device over the compute express link (CXL) connection. For example, when the cache requests to access a memory location over the connection, the solid-state drive is required to provide a response within the access time specified by the host system in configuring the memory services of the solid-state drive.

Optionally, the host system can specify how much of the memory device attached by the solid-state drive is required to be non-volatile such that when an external power supply to the solid-state drive fails, the data in the non-volatile portion of the memory device attached by the solid-state drive to the host system is not lost. The non-volatile portion can be implemented by the solid-state drive via non-volatile memory, or volatile memory with a backup power source to continue operations of copying data from the volatile memory to non-volatile memory during the disruption of the external power supply to the solid-state drive.

Optionally, the host system can specify whether the solid-state drive is to attach a memory device to the host system over the compute express link (CXL) connection.

For example, the solid-state drive can have an area configured to store the configuration parameters of the memory device to be attached to the host system via the compute express link (CXL) connection. When the solid-state drive reboots, starts up, or powers up, the solid-state drive can allocate, according to the configuration parameters stored in the area, a portion of its memory resources as a memory device for attachment to the host system. After the solid-state drive configures the memory services according to the configuration parameters stored in the area, the host system can access, via the cache, through execution of load instructions and store instructions identifying the corresponding physical memory addresses. The solid-state drive can configure its remaining memory resources to provide storage services over the compute express link (CXL) connection. For example, a portion of its volatile random access memory can be allocated as a buffer memory reserved for the processing device(s) of the solid-state drive; and the buffer memory is inaccessible and non-addressable to the host system via load/store instructions.

When the solid-state drive is connected to the host system via a computer express link connection, the host system can send commands to adjust the configuration parameters stored in the area for the attachable memory device. Subsequently, the host system can request the solid-state drive to restart to attach, over the computer express link to the host system, a memory device with memory services configured according to the configuration parameters.

For example, the host system can be configured to issue a write command (or store commands) to save the configuration parameters at a predetermined logical block address (or predetermined memory addresses) in the area to customize the setting of the memory device configured to provide memory services over the computer express link connection.

Alternatively, a command having a command identifier that is different from a write command (or a store instruction) can be configured in the read-write protocol (or in the load-store protocol) to instruct the solid-state drive to adjust the configuration parameters stored in the area.

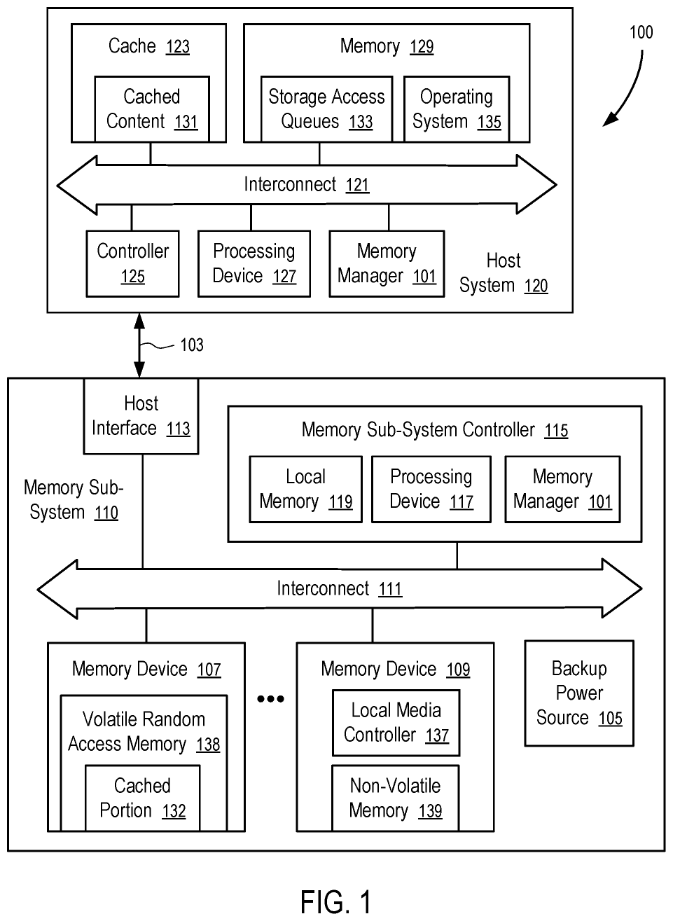

FIG. 1 illustrates an example computing system 100 that includes a memory sub-system 110 in accordance with some embodiments of the present disclosure. The memory sub-system 110 can include computer-readable storage media, such as one or more volatile memory devices (e.g., memory device 107), one or more non-volatile memory devices (e.g., memory device 109), or a combination of such.

In FIG. 1, the memory sub-system 110 is configured as a product of manufacture (e.g., a solid-state drive), usable as a component installed in a computing device.

The memory sub-system 110 further includes a host interface 113 for a physical connection 103 with a host system 120.

The host system 120 can have an interconnect 121 connecting a cache 123, a memory 129, a memory controller 125, a processing device 127, and a memory manager 101 configured to set up the memory services of the memory sub-system 110.

The memory manager 101 in the host system 120 can be implemented at least in part via instructions executed by the processing device 127, or via logic circuit, or both. The memory manager 101 in the host system 120 can send configuration parameters to the memory sub-system to customize or control a memory device attached by the memory sub-system 110 to the host system 120. Optionally, the memory manager 101 in the host system 120 is implemented as part of the operating system 135 of the host system 120, or a device driver configured to operate the memory sub-system 110, or a combination of such software components.

The connection 103 can be in accordance with the standard of compute express link (CXL), or other communication protocols that support cache-coherent memory access and storage access. Optionally, multiple physical connections 103 are configured to support cache-coherent memory access communications and support storage access communications.

The processing device 127 can be a microprocessor configured as a central processing unit (CPU) of a computing device. Instructions (e.g., load instructions, store instructions) executed in the processing device 127 can access memory 129 via the memory controller (125) and the cache 123. Further, when the memory sub-system 110 attaches a memory device over the connection 103 to the host system, instructions (e.g., load instructions, store instructions) executed in the processing device 127 can access the memory device via the memory controller (125) and the cache 123, in a way similar to the accessing of the memory 129.

For example, in response to execution of a load instruction in the processing device 127, the memory controller 125 can convert a logical memory address specified by the instruction to a physical memory address to request the cache 123 for memory access to retrieve data. For example, the physical memory address can be in the memory 129 of the host system 120, or in the memory device attached by the memory sub-system 110 over the connection 103 to the host system 120. If the data at the physical memory address is not already in the cache 123, the cache 123 can load the data from the corresponding physical address as the cached content 131. The cache 123 can provide the cached content 131 to service the request for memory access at the physical memory address.

For example, in response to execution of a store instruction in the processing device 127, the memory controller 125 can convert a logical memory address specified by the instruction to a physical memory address to request the cache 123 for memory access to store data. The cache 123 can hold the data of the store instruction as the cached content 131 and indicate that the corresponding data at the physical memory address is out of date. When the cache 123 needs to vacate a cache block (e.g., to load new data from different memory addresses, or to hold data of store instructions of different memory addresses), the cache 123 can flush the cached content 131 from the cache block to the corresponding physical memory addresses (e.g., in the memory 129 of the host system, or in the memory device attached by the memory sub-system 110 over the connection 103 to the host system 120).

The connection 103 between the host system 120 and the memory sub-system 110 can support a cache-coherent memory access protocol. Cache coherence ensures that: changes to a copy of the data corresponding to a memory address are propagated to other copies of the data corresponding to the memory address; and load/store accesses to a same memory address are seen by processing devices (e.g., 127) in a same order.

The operating system 135 can include routines of instructions programmed to process storage access requests from applications.

In some implementations, the host system 120 configures a portion of its memory (e.g., 129) to function as queues 133 for storage access messages. Such storage access messages can include read commands, write commands, erase commands, etc. A storage access command (e.g., read or write) can specify a logical block address for a data block in a storage device (e.g., attached by the memory sub-system 110 to the host system 120 over the connection 103). The storage device can retrieve the messages from the queues 133, execute the commands, and provide results in the queues 133 for further processing by the host system 120 (e.g., using routines in the operating system 135).

Typically, a data block addressed by a storage access command (e.g., read or write) has a size that is much bigger than a data unit accessible via a memory access instruction (e.g., load or store). Thus, storage access commands can be convenient for batch processing a large amount of data (e.g., data in a file managed by a file system) at the same time and in the same manner, with the help of the routines in the operating system 135. The memory access instructions can be efficient for accessing small pieces of data randomly without the overhead of routines in the operating system 135.

The memory sub-system 110 has an interconnect 111 connecting the host interface 113, a controller 115, and memory resources, such as memory devices 107, . . . , 109.

The controller 115 of the memory sub-system 110 can control the operations of the memory sub-system 110. For example, the operations of the memory sub-system 110 can be responsive to the storage access messages in the queues 133, or responsive to memory access requests from the cache 123.

In some implementations, each of the memory devices (e.g., 107, . . . , 109) includes one or more integrated circuit devices, each enclosed in a separate integrated circuit package. In other implementations, each of the memory devices (e.g., 107, . . . , 109) is configured on an integrated circuit die; and the memory devices (e.g., 107, . . . , 109) can be configured in a same integrated circuit device enclosed within a same integrated circuit package. In further implementations, the memory sub-system 110 is implemented as an integrated circuit device having an integrated circuit package enclosing the memory devices 107, . . . , 109, the controller 115, and the host interface 113.

For example, a memory device 107 of the memory sub-system 110 can have volatile random access memory 138 that is faster than the non-volatile memory 139 of a memory device 109 of the memory sub-system 110. Thus, the non-volatile memory 139 can be used to provide the storage capacity of the memory sub-system 110 to retain data. At least a portion of the storage capacity can be used to provide storage services to the host system 120. Optionally, a portion of the volatile random access memory 138 can be used to provide cache-coherent memory services to the host system 120. The remaining portion of the volatile random access memory 138 can be used to provide buffer services to the controller 115 in processing the storage access messages in the queues 133 and in performing other operations (e.g., wear leveling, garbage collection, error detection and correction, encryption).

When the volatile random address memory 138 is used to buffer data received from the host system 120 before saving into the non-volatile memory 139, the data in the volatile random address memory 138 can be lost when the power to the memory device 107 is interrupted. To prevent data loss, the memory sub-system 110 can have a backup power source 105 that can be sufficient to operate the memory sub-system 110 for a period of time to allow the controller 115 to commit the buffered data from the volatile random access memory 138 into the non-volatile memory 139 in the event of disruption of an external power supply to the memory sub-system 110.

Optionally, the fast memory 138 can be implemented via non-volatile memory (e.g., cross-point memory); and the backup power source 105 can be eliminated. Alternatively, a combination of fast non-volatile memory and fast volatile memory can be configured in the memory sub-system 110 for memory services and buffer services.

The host system 120 can send a memory attachment capability query over the connection 103 to the memory sub-system 110. In response, the memory sub-system 110 can provide a response identifying: whether the memory sub-system 110 can provide cache-coherent memory services over the connection 103, what is the amount of memory that is attachable to provide the memory services over the connection 103, how much of the memory available for the memory services to the host system 120 is considered non-volatile (e.g., implemented via non-volatile memory, or backed with a backup power source 105), what is the access time of the memory that can be allocated to the memory services to the host system 120, etc.

The host system 120 can send a request over the connection 103 to the memory sub-system 110 to configure the memory services provided by the memory sub-system 110 to the host system 120. In the request, the host system 120 can specify: whether the memory sub-system 110 is to provide cache-coherent memory services over the connection 103, what is the amount of memory that is provided as the memory services over the connection 103, how much of the memory provided over the connection 103 is considered non-volatile (e.g., implemented via non-volatile memory, or backed with a backup power source 105), what is the access time of the memory is provided as the memory services to the host system 120, etc. In response, the memory sub-system 110 can partition its resources (e.g., memory devices 107, . . . , 109) and provide the requested memory services over the connection 103.

When a portion of the memory 138 is configured to provide memory services over the connection 103, the host system 120 can access a cached portion 132 of the memory 138 via load instructions and store instructions and the cache 123. The non-volatile memory 139 can be accessed via read commands and write commands transmitted via the queues 133 configured in the memory 129 of the host system 120.

The memory manager 101 in the memory sub-system 110 can implement the memory services provided over the connection 103 as a memory device attached to the host system 120 using the resources of the memory sub-system 110. For example, the memory manager 101 can allocate a portion of the fast, volatile memory 138 as a cache memory to access a memory space hosted in the slow, non-volatile memory 139. Optionally, the memory space can overlap with a portion of the storage space provided by the memory sub-system 110 to the host system 120. Thus, a portion of the non-volatile memory 139 can be accessible via the memory services and via the storage services.

In general, the memory manager 101 can be implemented in the host system 120, or in the memory sub-system 110, or partially in the host system 120 and partially in the memory sub-system 110. The memory manager 101 in the memory sub-system 110 can be implemented at least in part via instructions (e.g., firmware) executed by the processing device 117 of the controller 115 of the memory sub-system 110, or via logic circuit, or both.

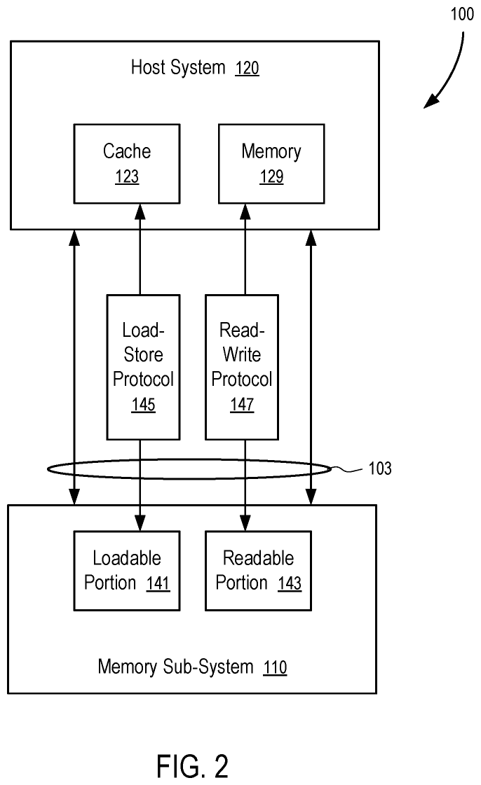

FIG. 2 shows a memory sub-system configured to offer both memory services and storage services to a host system over a physical connection according to one embodiment. For example, the memory sub-system 110 and the host system 120 of FIG. 2 can be implemented in a way as the computing system 100 of FIG. 1.

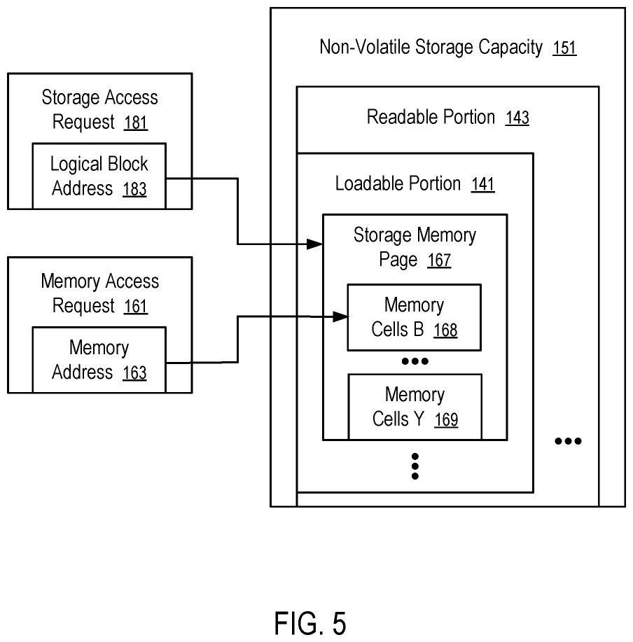

In FIG. 2, the memory resources (e.g., memory devices 107, . . . , 109) of the memory sub-system 110 are partitioned into a loadable portion 141 and a readable portion 143 (and an optional portion for buffer memory 149 in some cases, as in FIG. 5). A physical connection 103 between the host system 120 and the memory sub-system 110 can support a protocol 145 for load instructions and store instructions to access memory services provided in the loadable portion 141. For example, the load instructions and store instructions can be executed via the cache 123. The connection 103 can further support a protocol 147 for read commands and write commands to access storage services provided in the readable portion 143. For example, the read commands and write commands can be provide via the queues 133 configured in the memory 129 of the host system 120. For example, a physical connection 103 supporting a computer express link can be used to connect the host system 120 and the memory sub-system 110.

FIG. 2 illustrates an example of a same physical connection 103 (e.g., computer express link connection) configured to facilitate both memory access communications according to a protocol 145, and storage access communications according to another protocol 147. In general, separate physical connections can be used to provide the host system 120 with memory access according to a protocol 145 for memory access, and storage access according to another protocol 147 for storage access.

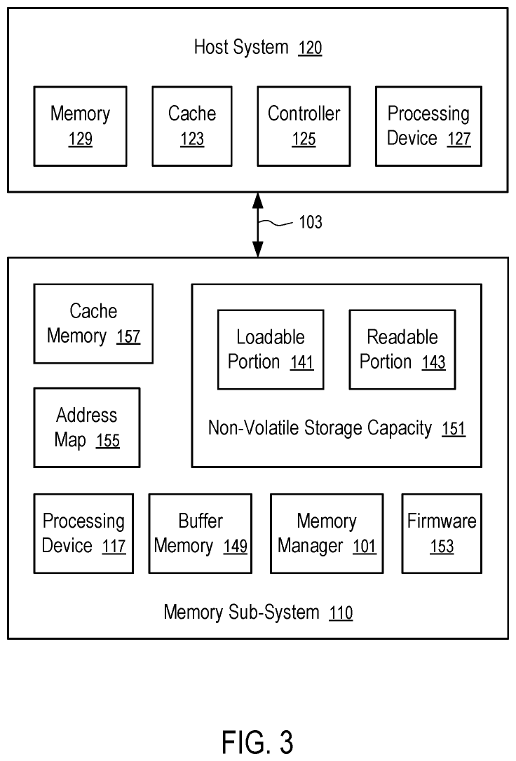

FIG. 3 shows a memory sub-system configured to provide memory services using a portion of the non-volatile storage capacity of the memory sub-system according to one embodiment. For example, the memory services of FIG. 3 can be implemented in the computing systems 100 of FIG. 1 and FIG. 2.

In FIG. 3, the memory sub-system 110 has a non-volatile storage capacity 151. The non-volatile storage capacity 151 can be implemented using non-volatile memory (e.g., 139) of memory devices (e.g., 109) of the memory sub-system 110.

A loadable portion 141 of the non-volatile storage capacity 151 can be allocated to provide a memory space of a memory device attached by the memory sub-system 110 over the connection 103 to the host system 120. The host system 120 can use a cache-coherent memory access protocol (e.g., 145) to access the loadable portion 141 over the connection 103, as in FIG. 2.

A readable portion 143 of the non-volatile storage capacity 151 can be allocated to provide a storage space of a storage device attached by the memory sub-system 110 over the connection 103 to the host system 120. The host system 120 can use a storage access protocol (e.g., 147) to access the readable portion 143 over the connection 103, as in FIG. 2.

A portion of the volatile random access memory 138 of the memory sub-system 110 can be allocated as a cache memory 157 to implement the memory services provided by the memory sub-system 110 to the host system 120 over the connect 103.

A memory manager 101 of the memory sub-system 110 can be configured to use the cache memory 157 to support and accelerate the memory operations addressing active pages of the loadable portion 141. The memory manager 101 can be implemented via instructions executed in the processing device 117 of the memory sub-system 110, or logic circuits, or both.

The remaining portion of the volatile random access memory 138 of the memory sub-system 110 can be used by the memory sub-system 110 as a buffer memory 149 in running the firmware 153 and the memory manager 101.

When a page of the loadable portion 141 is being used by the host system 120, the memory manager 101 can allocate a page in the cache memory 157 as the proxy or cache of the page of the loadable portion 141. The memory manager 101 can operate an address map 155 to identify the dynamic correlation between the pages in the cache memory 157 and the pages in the loadable portion 141.

When the address map 155 indicates that a page of the loadable portion 141 has a corresponding page of the cache memory 157, memory access requests addressed to the page of the loadable portion 141 can be performed on the corresponding page of the cache memory 157. For example, when the host system 120 uses the cache-coherent memory access protocol 145 to store data into memory addresses identifying the page of the loadable portion 141, the memory manager 101 can identify the corresponding addresses of memory cells in the corresponding page of the cache memory 157 for the memory sub-system 110 to store the data into the corresponding page of the cache memory 157 initially. The memory sub-system 110 can indicate (e.g., using the address map 155) that the corresponding page of the cache memory 157 is dirty, for having data that is to be saved to the corresponding page of the loadable portion 141. After the data in the page of the cache memory 157 is saved into the page of the loadable portion 141, the page of the cache memory 157 becomes clean, for having the same content as the corresponding page of the loadable portion 141.

The cache memory 157 has less pages than the loadable portion 141. When the pages of the cache memory 157 are all used to represent certain active pages in the loadable portion 141, the cache memory 157 becomes full. The memory manager 101 can identify one or more pages in the cache memory 157 as candidates for representing alternative pages of the loadable portion 141 that will be actively used by the host system 120. For example, the memory manager 101 can be configured to identify the candidate pages using the techniques of least recently used (LRU), first in first out (FIFO), optimal page replacement, etc.

If the address map 155 indicates that a candidate page is dirty, the memory manager 101 can proactively make the page clean by writing its content to the corresponding page in the loadable portion 141.

Subsequently, when the host system 120 uses the cache-coherent protocol 145 to access a page of the loadable portion 141 that is not already represented by a corresponding page in the cache memory 157, the memory manager 101 can update the address map 155 to use a clean candidate page of the cache memory 157 to represent the accessed page of the loadable portion 141. The memory manager 101 can read the accessed page of the loadable portion 141 to retrieve page data and store the page data into the clean candidate page of the cache memory 157, discarding the existing content of the clean candidate page. No data is lost, because the existing content is the same as in the page previously represented by the candidate page. The address map 155 can be updated to identify the accessed page as being represented by the candidate page.

A memory access causing the candidate page to be allocated to represent the accessed page of the loadable portion 141 can request the retrieval of data from the accessed page. In response to such a memory access, the memory manager 101 can be configured to store the page data, retrieved from the loadable portion 141, into the candidate page. Subsequently, the candidate page can be addressed to service the memory access, as if the candidate page were the accessed page.

Since retrieving data from the loadable portion 141 takes a time period longer than servicing data from the cache memory 157, a significant delay can occur in servicing the memory access that causes the candidate page to be allocated and setup to represent a page in the loadable portion 141. Optionally, the memory manager 101 can indicate an error in a response to the memory access while retrieving the page data from the loadable portion 141. Subsequently, when the host system 120 makes the same memory access, the candidate page can be ready to represent the accessed page; and the memory manager 101 can use the candidate page to service the memory access, as if the candidate page were the accessed page. Servicing the memory access using the cache memory 157 is faster than servicing the memory access using the loadable portion 141 in the non-volatile storage capacity 151.

A memory access causing the candidate page to be allocated to represent the accessed page of the loadable portion 141 can request storing of data into the accessed page. In response to such a memory access, the memory manager 101 can be configured to store the combined data, representative of the page data being updated by the memory access, into the candidate page. The candidate page then becomes dirty (e.g., via an indication in the address map 155), until the changes are saved to the corresponding page in the loadable portion 141.

For example, after the memory manager 101 allocates a candidate page of the cache memory 157 to represent an accessed page of the loadable portion 141 in response to a memory access to store data at a memory address, the memory manager 101 can store the data to the corresponding memory address in the cache memory 157 in parallel with reading the accessed page of the loadable portion 141. After the data of the access page is available, the memory manager 101 can write the data to the remaining addresses in the candidate page, skipping the memory address that has stored the data provided by the memory access from the host system 120.

Alternatively, the memory manager 101 can keep, in the buffer memory 149 temporarily, the data received from the host system 120 in the memory access while retrieving the page data from the accessed page in the loadable portion 141. When the page data is available, the memory manager 101 can update the page data (e.g., in the buffer memory 149) and move the updated page data to the candidate page of the cache memory 157. Optionally, the updating can be performed in placed in the candidate page of the cache memory 157.

In some implementations, the non-volatile memory 139 of the memory sub-system 110 has a structure of pages of memory cells and blocks of memory cell pages. A page of memory cells is a smallest unit for programming memory cells to store data. Memory cells in a page are configured to be programmed together in an atomic programming operation. A block of memory cell pages is a smallest unit for erasing memory cells to allow individual memory cell pages in the block to be programmed to store data. Memory cell pages in a block are configured to be erased together in an atomic erasing operation.

The pages of the memory space in the loadable portion 141, to be represented by the pages in the cache memory 157, can be configured to align with memory cell pages of the non-volatile memory 139. Thus, when a dirty page in the cache memory 157 is stored into the loadable portion 141, the number of programming operations to save the data from the page of the cache memory 157 is minimized. For example, a page in the cache memory 157 can be configured to represent a memory cell page in the loadable portion 141. When the page of cache memory 157 is dirty, the corresponding memory cell page can be marked as no longer in use and thus can be erased. When the page of the cache memory 157 is to be stored back into the loadable portion, the memory sub-system 110 can allocate a free memory cell page that has been erased and program the allocated memory cell page to store the data of the page of the cache memory 157.

For example, the firmware 153 can include a flash translation layer (FTL) configured to translate the logical storage addresses to physical memory cell addresses in the non-volatile storage capacity 151. Instead of mapping a page of the cache memory 157 to a fixed memory cell page, the memory manager 101 can configure the address map 155 to map the page of the cache memory 157 to a logical storage page that can be mapped by the flash translation layer (FTL) to a dynamically allocated memory cell page to store the data of the page in the cache memory 157.

Optionally, the loadable portion 141 can also be configured to be accessible via the storage access protocol 147 over the connection 103. For example, the memory sub-system 110 can create a namespace of the non-volatile storage capacity 151 and allocate the namespace to the loadable portion 141. Storage locations in the namespace, and thus, the loadable portion 141, can be addressed via logical block addresses in the namespace; and the host system 120 can use write commands and read commands in the storage access protocol 147 to write data into and retrieve data from the loadable portion 141. Further, locations in the loadable portion 141 can be addressed via memory addresses that are mapped to the namespace via the address map 155 (and the address map of the flash translation layer (FTL)); and the host system 120 can use load instructions and store instructions to access, via the cache-coherent memory access protocol 145, to store data into and load data from the loadable portion 141.

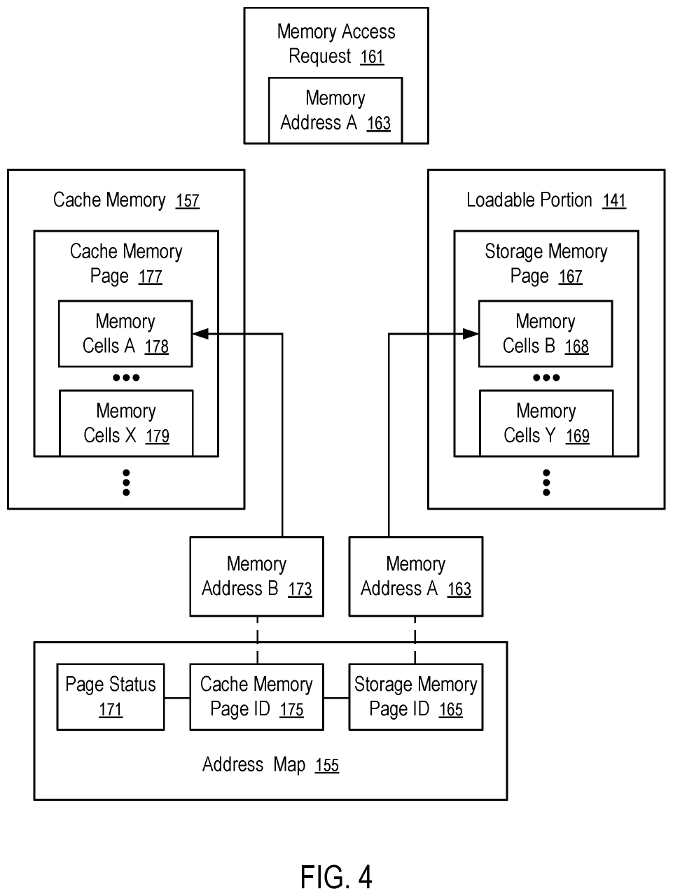

FIG. 4 illustrates operations configured in a memory sub-system to respond to a memory access request according to one embodiment. For example, the operations of FIG. 4 can be implemented in a memory sub-system 110 of FIG. 3 in computing systems 100 of FIG. 1 and FIG. 2.

In FIG. 4, a memory access request 161 is transmitted from a host system 120 over a connection 103 to a host interface 113 of the memory sub-system 110. For example, the memory access request 161 can be in accordance with a cache-coherent memory access protocol 145.

The memory access request 161 identifies a memory address 163 representative of a memory location in a memory device attached by the memory sub-system 110 over the connection 103 to the host system 120.

The memory sub-system 110 manages an address map 155 identifying the correlations between pages (e.g., 177) of the cache memory 157 and pages (e.g., 167) of storage memory in the loadable portion 141.

The cache memory 157 is faster than the loadable portion 141, but has less pages than the loadable portion 141. The pages (e.g., 177) of the cache memory 157 can be used to represent a portion of the storage pages (e.g., 167) that are being actively used by the host system 120.

The memory space in the loadable portion 141 is pre-divided into pages 167. Thus, the memory sub-system 110 can compute, from the memory address 163, a page identification 165 of the storage memory page 167 that contains a memory location identified by the memory address 163.

The memory sub-system 110 can determine whether the storage memory page identification 165 is in the address map 155 and whether it is associated with a page identification 175 of a cache memory page 177.

If a cache memory page 177 has been allocated to represent the storage memory page 167, the address map 155 contains data associating the storage memory page identification 165 and the cache memory page identification 175. Then, the memory sub-system 110 can convert the memory address 163 in the storage memory page 167 into the corresponding memory address 173 in the corresponding cache memory page 177.

For example, when the memory address 163 identifies a storage location at memory cells 168 in the storage page 167, the memory sub-system 110 can determine the memory address 173 of the corresponding memory cells 178 that represent the memory cells 168. Thus, the memory access request 161 is applied to the corresponding memory operations to the memory cells 178 at the memory address 173.

For example, when the memory access request 161 is for loading data from the memory address 163, the memory sub-system 110 can retrieve data from the memory cells 178 to provide a response to the request 161.

For example, when the memory access request 161 is for storing data to the memory address 163, the memory sub-system 110 can store the data to the memory cells 178 and update the page status 171 to indicate that the cache memory page 177 is dirty, indicating that the page 177 contains data to be stored back to the storage memory page 167 identified by the storage memory page identification 165.

When the cache memory page 177 is dirty but is not being actively used by the host system 120 via memory access requests (e.g., 161), the memory sub-system 110 can retrieve the data from the cache memory page 177 and store the data into the storage memory page 167. Then, the memory sub-system 110 can update the page status 171 to indicate that the cache memory page 177 is clean, indicating that the page 177 contains the same data as the corresponding storage memory page 167.

When the memory access request 161 has a memory address 163 that is in a storage memory page 167 but the address map 155 indicates that the storage memory page 167 is not yet represented by a cache memory page (e.g., 177), the memory sub-system 110 can allocate a clean cache memory page (e.g., 177) (or a free cache memory page that has not yet been allocated to represent a storage memory page) to represent the storage memory page 167.

To set up the cache memory page 177 to represent the storage memory page 167, the memory sub-system 110 can retrieve data from the storage memory page 167 and store the data into the cache memory page 177. Further, the memory sub-system 110 can update the address map 155 to associate the page identification 175 of the cache memory page 177 to the page identification 165 of the storage memory page 167.

In some implementations, a cache memory page 177 is configured to represent a memory cell page 167 having memory cells 168, . . . , 169 that are structured in an integrated circuit memory device 109 to be programmed together to store data in an atomic programming operation. Thus, storing the data of the cache memory page 177 to the loadable portion 141 can be performed via a single, programming operation.

In a typical implementation, the cache memory 157 has less restriction and is faster than the non-volatile memory 139. For example, memory cells 178, . . . , 179 in the cache memory page 177 can be programmed separately to store data via separate programming operations.

In some implementations, a block of memory cell pages (e.g., 167) is configured in an integrated circuit memory device 109 to be erased together in order to allow the pages (e.g., 167) to be programmed to store data. To avoid unnecessary copying and erasing data, the memory sub-system 110 can use the storage memory page identification 165 to represent logical pages in the loadable portion 141. The logical pages can be further mapped to memory cell pages (e.g., 167).

Optionally, the flash translation layer (FTL) function of the firmware 153 of the memory sub-system 110 can be used to facilitate the map the logical pages to the memory cell pages (e.g., 167).

Optionally, the memory address 163 can be configured based on a logical storage space of the loadable portion 141. For example, a namespace of the non-volatile storage capacity 151 can be allocated to host the loadable portion 141. The flash translation layer (FTL) of the firmware 153 can translate a logical block address in the namespace into identifications of one or more memory cell pages (e.g., 167). The memory address space of the loadable portion 141 can have a predetermined relation to the logical block addresses in the namespace. Thus, the storage memory page identification 165 can be configured to be based on logical block addresses in the namespace for mapping to memory cell pages (e.g., 167).

Since the relation between the memory addresses (e.g., 163) for memory access requests (e.g., 161) and the logical block addresses in the namespace allocated for the loadable portion 141 is predetermined, the host system 120 has the options to address the memory cell pages (e.g., 167) via memory access requests (e.g., 161) using the cache-coherent memory access protocol 145, or via storage access requests using the storage access protocol 147, as in FIG. 5

FIG. 5 illustrates a configuration to allow a portion of the non-volatile storage capacity of the memory sub-system to be addressable via both memory services and storage services according to one embodiment. For example, the technique of FIG. 5 can be implemented in a memory sub-system 110 of FIG. 3 in a computing system 100 of FIG. 1 and FIG. 2.

In FIG. 5, the non-volatile storage capacity 151 can have a readable portion 143 configured to be accessible via storage access requests (e.g., 181) that use logical block addresses (e.g., 183) to address storage locations according to a storage access protocol 147 over a connection 103 between a memory sub-system 110 and a host system 120.

A portion 141 of the readable portion 143 can be attached by the memory sub-system 110 as a memory device over the connection 103 to the host system 120. Thus, the host system can use memory access requests 161 to access memory addresses (e.g., 163) in the loadable portion 141 over the connection 103 using a cache-coherent memory access protocol 147. For example, the memory access in FIG. 5 can be implemented as in FIG. 4.

Optionally, the logical block addresses (e.g., 183) can be configured to address memory cell pages (e.g., 167) in the non-volatile memory (e.g., 139) of the memory sub-system 110. Alternatively, a logical block address (e.g., 183) can be used to address a logical block having a plurality of memory cell pages (e.g., 167).

In contrast, a memory address (e.g., 163) is configured to identify a storage unit of a subset of memory cells (e.g., 168) in a memory cell page (e.g., 167).

Optionally, the memory sub-system 110 can allocate multiple namespaces of the non-volatile storage capacity 151 for the loadable portion 141. Thus, different portions of the memory device attached by the memory sub-system 110 can be accessed via different namespaces using the storage access protocol 147.

Optionally, the memory sub-system 110 can allocate multiple namespaces of the non-volatile storage capacity 151 for multiple loadable portions (e.g., 141) respectively. The loadable portions (e.g., 141) can be attached, over the connection 103, as separate memory spaces addressable by the host system 120 via the cache-coherent memory access protocol 145.

In response to the memory access request 161 or the storage access request 181, the memory sub-system 110 can determine whether the storage memory page 167 is cached in the cache memory 157 according to the address map 155. If so, the memory sub-system 110 can identify the cache memory page 177 and service the memory access request 161 using the cache memory page 177; otherwise, the memory sub-system 110 can cache the storage page 167 in the cache memory 157.

For example, a method to provide memory services using a storage capacity of a memory sub-system according to one embodiment can be implemented in a memory sub-system 110 of FIG. 3 in computing systems of FIG. 1 and FIG. 2 using the techniques of FIG. 4 and FIG. 5.

For example, the memory sub-system 110 can have a host interface 113 operable on a connection 103 to a host system 120 according to a storage access protocol (e.g., 147) and a cache-coherent memory access protocol (e.g., 145). The memory sub-system 110 can have a first non-volatile memory (e.g., 139) configured to provide a non-volatile storage capacity 151 of the memory sub-system 110 and a second volatile memory (e.g., 138) that is faster than the first memory (e.g., 139). A controller 115 of the memory sub-system 110 can be configured to: allocate a first page (e.g., 177) of the second memory (e.g., 138) to represent a second page (e.g., 167) in a memory space provided by a memory device attached by the memory sub-system to the host system over the connection; and operate the first page (e.g., 177) of the second memory (e.g., 138) in response to a memory access request 161 transmitted over the connection 103 according to the cache-coherent memory access protocol 145 to the host interface 113, when the memory access request 161 identifies a memory address 163 in the memory space.

For example, the controller 115 can be configured via firmware 153 to implement the operations of a memory manager 101 in the swapping of pages between the volatile memory 138 and the non-volatile memory 139 and the caching of pages in the cache memory 157. Optionally, each page (e.g., 167) cached in the volatile memory (e.g., 138) of the memory sub-system 110 can be configured to have a size of a memory cell page that is allocated to host a portion of the memory space addressable by the host system 120 using memory addresses (e.g., 163). Memory cells in each memory cell page are configured in an integrated circuit memory device (e.g., 109) to be programmed together in an atomic programming operation to store data.

Optionally, the memory manager 101 can allocate a portion 141 of a non-volatile storage capacity 151 of the memory sub-system 110 to a namespace, attach the namespace as a memory device to a host system 120 over a computer express link (CXL) connection 103 between a host interface 113 of the memory sub-system 110 and the host system 120, and provide the host system 120 with: storage access to the namespace using a storage access protocol 147 over the connection 103 and logical block addresses (e.g., 183) defined in the namespace; and memory access to a memory space, corresponding to the namespace, using a cache-coherent memory access protocol 145 over the connection 103 and memory addresses (e.g., 163). For example, the memory manager 101 can map the memory space to the namespace according to a predetermined relation such that the same data can be stored or retrieved via memory addresses and via logical block addresses.

In the method, a memory sub-system 110 attaches, over a connection 103 from a host interface 113 of the memory sub-system 110 to a host system 120, a memory device having a memory space (e.g., loadable portion 141) configured in first memory (e.g., 139) of the memory sub-system 110.

For example, the memory sub-system 110 can be a solid-state drive having the volatile random access memory 138 and non-volatile memory 139.

In the method, the memory sub-system 110 attaches, over the connection 103 from the host interface 113 of the memory sub-system 110 to the host system 120, a storage device having a storage space (e.g., readable portion 143) configured in the first memory (e.g., 139) of the memory sub-system 110.

Optionally, the storage space (e.g., readable portion 143) coincides with (or contains) the memory space (e.g., loadable portion 141).

In the method, the memory sub-system 110 allocates, an amount of second memory (e.g., 138), faster than the first memory (e.g., 139), to represent pages of the memory space (e.g., loadable portion 141) in servicing memory access requests (e.g., 161) in the memory space.

In the method, the memory sub-system 110 manages an address map 155 configured to identify correlations between pages (e.g., 177) of the second memory (e.g., 138) and corresponding pages (e.g., 167) of the memory space represented by the pages (e.g., 177) of the second memory (e.g., 138).

For example, the address map 155 can include data associating a first identification 175 of the first page (e.g., 177) with a second identification 165 of a second page (e.g., 167) of the memory space.

Optionally, the identification 165 of the second page (e.g., 167) can be based on a logical block address 183 in the storage space.

For example, a flash translation layer (FTL) of the memory sub-system 110 can be used to map the logical block address 183 to one or more pages (e.g., 167) of memory cells (e.g., 168, . . . , 169) in the memory sub-system 110. Thus, the physical locations of the memory address 163 can change in the non-volatile memory 139 based on the mapping of the flash translation layer (FTL).

In the method, the memory sub-system 110 operates a first page 177 of the second memory (e.g., 138) in response to a memory access request 161 transmitted over the connection 103 according to a cache-coherent memory access protocol 145 to identify a memory address 163 in the memory space.

Optionally, the first page 177 of the second memory (e.g., 138) is configured to represent a memory cell page having memory cells 168, . . . , 169 configured to be programmed together to store data in one atomic programming operating. Thus, the memory size of a cache memory page 177 is equal to the memory size of a memory cell page 167.

The memory manager 101 can be configured to swap a content of the second page 167 from the first memory (e.g., 139) into the first page 177 in response to the host system 120 accessing memory addresses (e.g., 163) in the second page 167 according to the cache-coherent memory access protocol.

The memory manager 101 can be configured to save a content of the first page 177 into the first memory (e.g., 139) in response to a determination that the host system 120 is not actively accessing the second page 167. The saving of the content of the first page 177 can be performed proactively before the host system 120 accessing a third page in the memory space that will cause the memory manager 101 to use the first page 177 to represent the third page (e.g., based on a page replacement technique, such as the least recently used (LRU), first in first out (FIFO), optimal page replacement, etc.).

For example, in response to the memory access request 161 identifying the memory address 163, the memory manager 101 can determine that the second page 167 of the memory space is not yet represented by any page in the second memory 138. In response, the memory manager 101 can allocate the first page 177 of the second memory 138, retrieve page data from the memory cell page (e.g., 167), store the page data into the first page 177 of the second memory 138, and update the address map 155 to indicate that the first page 177 represents the second page 167.

If the memory access request 161 is configured to store first data into the memory address 163, the memory manager 101 can store the first data into the first 155 to indicate that the first page 171 has content to be stored into the second memory 139.

Optionally, in response to the memory access request 161 being configured to store the first data into the memory address 163, the memory manager 101 can store data identifying that the memory cell page 167 previously used to host the second page containing the memory address 163 is no longer in use. Thus, the firmware 153 can reclaim the storage space of the memory cell page 167 during a background operation of garbage collection.

For example, in response to the host system is actively using other pages of the memory space and thus not actively using the second page 167 of the memory space, the memory manager 101 can store the content of the first page 177 into the second memory 139, and update a page status 171 in the address map 155 to indicate that the content in the first page 177 is same as in a corresponding page in the second memory. Thus, the first page 177 is clean and can be reallocated to represent another page of the memory space used by the host system 120.

For example, to save the content of the first page 177, the flash translation layer can allocate a memory cell page 167; and the memory sub-system 110 can perform an atomic programming operating to store the content in the memory cell page 167. The memory manager 101 can then update the address map 155 to indicate that the cache memory page 177 is clean and represents the page hosted in the memory cell page 167.

In the method, the memory sub-system 110 operates the first memory (e.g., 139) in response to a storage access request transmitted over the connection 103 according to a storage access protocol 147 to identify a logical block address in the storage space.

For example, when the logical block address identifies a storage location outside of the loadable portion 141, the flash translation layer (FTL) of the memory sub-system 110 can determine the memory cells in the non-volatile memory 139 used for the logical block address and service the storage access request via reading or programming the memory cells.

When the logical block address identifies a storage location inside of the loadable portion 141, the memory manager 101 can determine whether a portion of the memory cells in the non-volatile memory 139 addressed by the logical block address is represented by a page (e.g., 177) in the cache memory 157. If so, the memory sub-system 110 can service the storage request via the cache memory page (e.g., 177) and the first memory for the remaining portion of the logical block address that is not represented by pages in the cache memory 157.

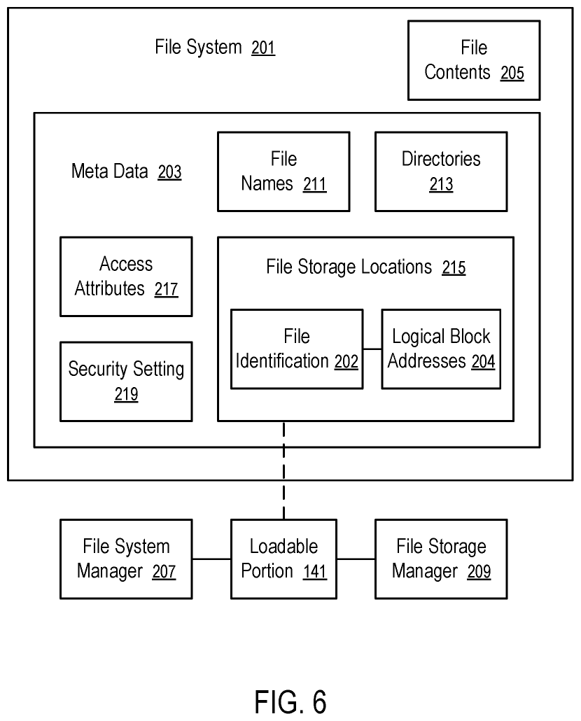

FIG. 6 shows a technique of file storage management in a computing system according to one embodiment.

For example, the technique of FIG. 6 can be implemented in a memory sub-system 110 of FIG. 3 in computing systems of FIG. 1 and FIG. 2 and optionally used in connection the techniques of FIG. 4 and FIG. 5.

In FIG. 6, a file system 201 is configured to store contents 205 of files. The files can be organized using meta data 203, such as names 211 of the files, directories 213 of the files, access attributes 217 of the files, security setting 219 of the files, etc. The structure and access control features of the file system 201 can be used to simplify collaborations across processes and systems.

The file system 201 can be mounted at least in part in a non-volatile storage capacity 151 of the memory sub-system 110 (e.g., readable portion 143) that is accessible to the host system 120 over the connection 103 using a storage access protocol 147.

Alternatively, or in combination, the file system 201 can be mounted at least in part in a memory space offered by the memory sub-system 110 (e.g., loadable portion 141) that is accessible to the host system 120 over the connection 103 using a cache-coherent memory access protocol 145.

Alternatively, or in combination, the file system 201 can be mounted at least in part in a memory 129 of the host system, and/or in another memory sub-system.

A file system manager 207 running in the host system 120 is configured to manage the creation and modification of various aspects of the meta data 203, such as the file names 211, the directories 213, the access attributes 217, the security settings 219, etc.

A file storage manager 209 configured in the memory sub-system 110 is configured to manage the storage locations 215 of the files stored in the memory sub-system 110.

For example, a file having an identification 202 in the file system 201 can be stored in the memory sub-system 110 (e.g., in the loadable portion 141, or in the readable portion 143). To store the contents 205 of the file, the file storage manager 209 in the memory sub-system 110 is configured to allocate storage resources (e.g., logical storage blocks) identified using one or more logical block addresses 204 for the storage of the file, such as the contents of the file. The file storage manager 209 can identify the logical block addresses 204 assigned to the file having the identification 202 and update the file storage locations 215 in the meta data 203.

An application can access a portion of the contents 205 based on a reference to a storage location within the file having the identification 202. The storage location in a contiguous file space defined logically for the file, as referenced in the application, can be translated by the file system manager 207 using the file storage locations 215 into a storage location that is independent of the file, that is implemented in the memory sub-system 110, and that is usable by the host system 120 in accessing the memory sub-system 110 using a protocol (e.g., 145 or 147) over the connection 103. For example, the storage location in the memory sub-system 110 can be represented by a logical block address 204 configured to reference a block of storage space of a predetermined size in the memory sub-system 110 (e.g., a logical block address defined in a namespace of the storage capacity 151). The definition of the logical block address 204 is independent of the file and the file system 201. The host system 120 can use storage access queues 133 and the logical block address 204 to request the memory sub-system 110, over the connection 103 using the storage access protocol 147, to read contents 205 from and write contents 205 into the file, without the memory sub-system 110 being aware of the association of the operations and the file and the file system 201.

When there are changes in the storage resources allocated to the file represented by the identification 202, the file storage manager 209 in the memory sub-system 110 can be used to update the file storage locations 215 for the file. As a result, the memory sub-system 110 is aware of which logical block addresses 204 are in use in the file system 201 and which logical block addresses are no longer in use. Therefore, it is not necessary for the host system 120 to issue commands to identify logical block addresses 204 that are no longer in use in order for the memory sub-system to reclaim their storage resources.

The file system manager 207 running in the host system 120 and the file storage manager 209 in the memory sub-system 110 can communicate with each other via the loadable portion 141 to facilitate the management and usages of the file storage locations 215.

For example, when the file system manager 207 is to expand the file space of the file having the identification 202, the file system manager 207 can request, via the loadable portion 141, the file storage manager 209 to allocate a block of storage resource represented by one or more logical block addresses 204.

For example, a message queue can be configured in the loadable portion 141 for the file system manager 207 to send requests to the file storage manager 209 and for the file storage manager 209 to send responses to the file system manager 207.

In general, the file storage manager 209 can add, remove, and change the logical block addresses 204 associated with the file identification 202 to represent the storage resources allocated to the file having the identification 202.

Optionally, the file storage manager 209 and the file system manager 207 can share the file storage locations 215 via the loadable portion 141 to reduce communications performed via the message queue.

For example, at least a portion of the meta data 203, including the file storage locations 215, can be configured in the loadable portion 141 for access by both the file system manager 207 and the file storage manager 209. The file system manager 207 can access the file storage locations 215 using the cache-coherent memory access protocol 145 over the connection 103; and the file storage manager 209 can access the file storage locations 215 via a local connection within the memory sub-system 110 without using the connection 103.

For example, the meta data 203 of the file contents 205 stored in the memory sub-system 110 can be configured in the loadable portion 141.

Optionally, the file system manager 207 can change the file storage locations 215. The file storage manager 209 can monitor the changes via monitoring memory operations in the region of the loadable portion 141 configured to store the file storage locations 215. Optionally, the file storage manager 209 can check the content of the file storage locations 215 to identify logical block addresses 204 that are no longer being used by the file system 201. Reclaiming the storage resources of the logical block addresses 204 that are no longer being used by the file system 201 can be performed in connection with background operations, such as erasing, wear leveling, garbage collection, etc., with minimized or reduced impact on the performance of the memory and storage services provided to the host system 120.

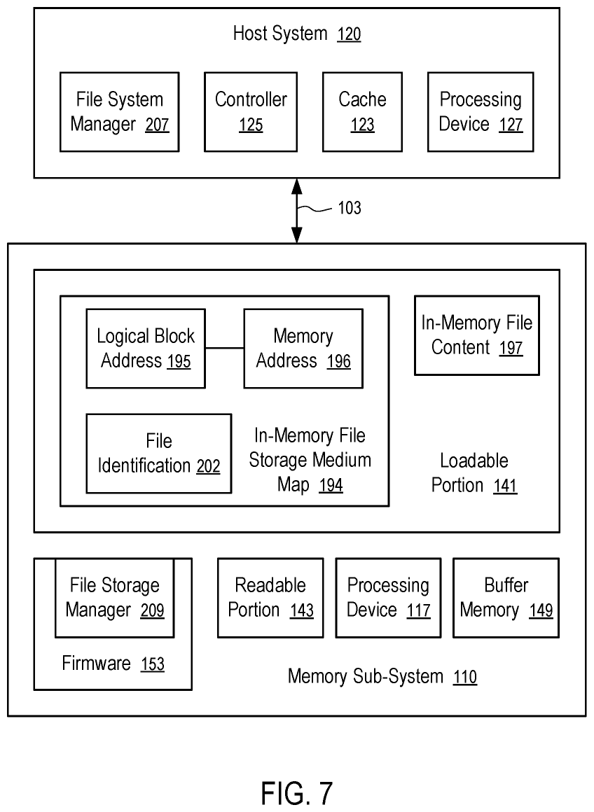

FIG. 7 shows a memory sub-system configured to manage storage locations of in-memory files according to one embodiment. For example, the technique of FIG. 6 can be implemented in the memory sub-system 110 of FIG. 7.

In FIG. 7, the host system 120 runs a file system manager 207 to mount an in-memory file system 201 at least in part in the loadable portion 141 of the memory sub-system 110.

The memory sub-system 110 has a file storage manager 209, configured as part of firmware 153, to manage the in-memory file storage medium map 194.

For example, a file having an identification 202 in the in-memory file system 201 has content 197 stored in the loadable portion 141. The medium map 194 can be configured as part of the file storage locations 215 of the meta data 203 of the file system 201. The medium map 194 identifies, for the file identification 202, the logical block addresses (e.g., 195) allocated to represent the storage resources assigned and mapped to form the contiguous logical storage space of the file. Alternatively, in combination, the medium map 194 identifies, for the file identification 202, the memory addresses (e.g., 196) that can be used, over the connection 103 using the cache-coherent memory access protocol 145, to access the portion of the loadable portion 141 allocated to store the file having the identification 202 in the file system 201.

The file system manager 207 can access the medium map 194 over the connection 103 using the cache-coherent memory access protocol 145 to determine the memory addresses (e.g., 196) of locations in the file for storing or retrieving the content 197. Optionally, the memory space provided by the loadable portion 141 can be mapped to a logical storage space; and a fixed, predetermined mapping between the logical block addresses in the logical storage space and the memory addresses in the memory space provided by the loadable portion 141 can be used.

Optionally, the storage medium of the file having the identification 202 can be configured in the medium map 194 as one or more disconnected memory regions having the memory addresses (e.g., 196) allocated for the file, with or without using the logical block addresses (e.g., 195). For improved efficiency in mapping, a memory region configured for assignment for a file can have a predetermined size that is equal to (or a fraction of) the size of a logical block of storage space represented by a logical block address (e.g., 195).

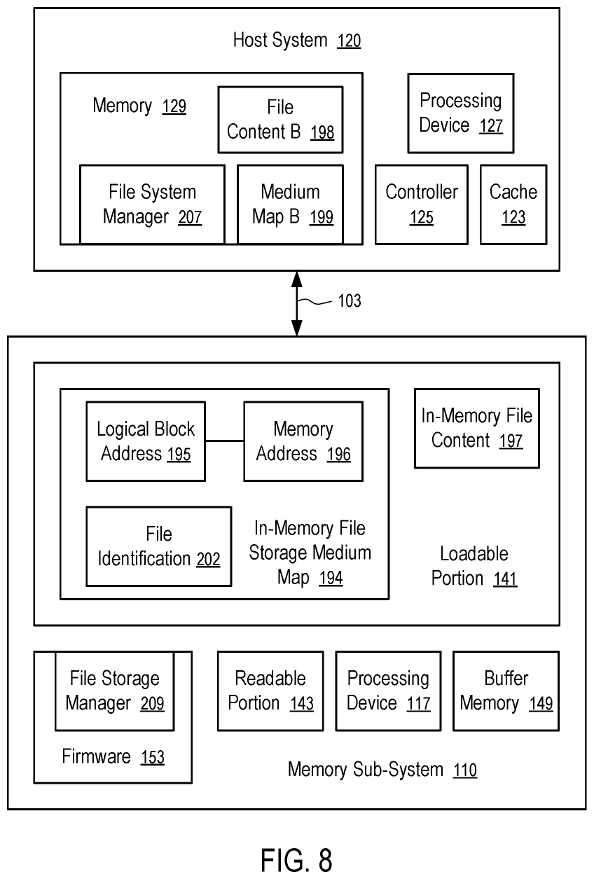

Optionally, an in-memory file system 201 can be partially in the loadable portion 141 of the memory sub-system 110 and partially in the memory 129 of the host system 120 as in FIG. 8.

The file storage manager 209 can be configured to assign memory regions in the loadable portion each having the same size as the size of a logical block represented by a logical block address 195. Thus, the memory addresses within the logical block can be determined from the starting memory address 196 of the logical block, and an offset from the starting memory address 196. Thus, it is sufficient to identify a starting memory address 196 for the logical block address 195.

Alternatively, the file storage manager 209 can assign to a logical block non-contiguous memory regions each having a size that is a fraction of the size of the logical block. Thus, the memory regions in the loadable portion 141 allocated to implement the logical block can have a predetermined number of memory addresses, each configured to identify a starting address of a contiguous memory region used to implement the logical block.

FIG. 8 shows the storage management of an in-memory file system that is partially in a memory sub-system and partially in the memory of a host system according to one embodiment. For example, the technique of FIG. 6 can be implemented in the memory sub-system 110 of FIG. 8.

In FIG. 8, the host system 120 runs a file system manager 207 to mount an in-memory file system 201. A portion of the in-memory file system 201 is configured in the loadable portion 141 of the memory sub-system 110 (e.g., to store file content 197); and another portion of the in-memory file system 201 is configured in the memory 129 of the host system 120.

As in FIG. 7, the memory sub-system 110 in FIG. 8 has a file storage manager 209, configured as part of firmware 153, to manage the in-memory file storage medium map 194 for the portion of the file system 201 configured in the loadable portion 141 (e.g., to store a file having an identification 202).

The file system manager 207 is configured to manage the medium map 199 for the portion of the file system 201 (e.g., file content 198) hosted in the memory 129 of the host system 120.

When the host system 120 accesses a file in the memory 129, the file system manager 207 does not require access to the loadable portion 141 and does not need assistance from the file storage manager 209. However, when the host system 120 accesses a file having the identification 202 and having a content 197 stored in the loadable portion 141, the file system manager 207 can retrieve the memory addresses (e.g., 196) associated in the file identification 202, and use the cache-coherent memory access protocol to load data from and store data to the memory addresses (e.g., 196), as in FIG. 7.

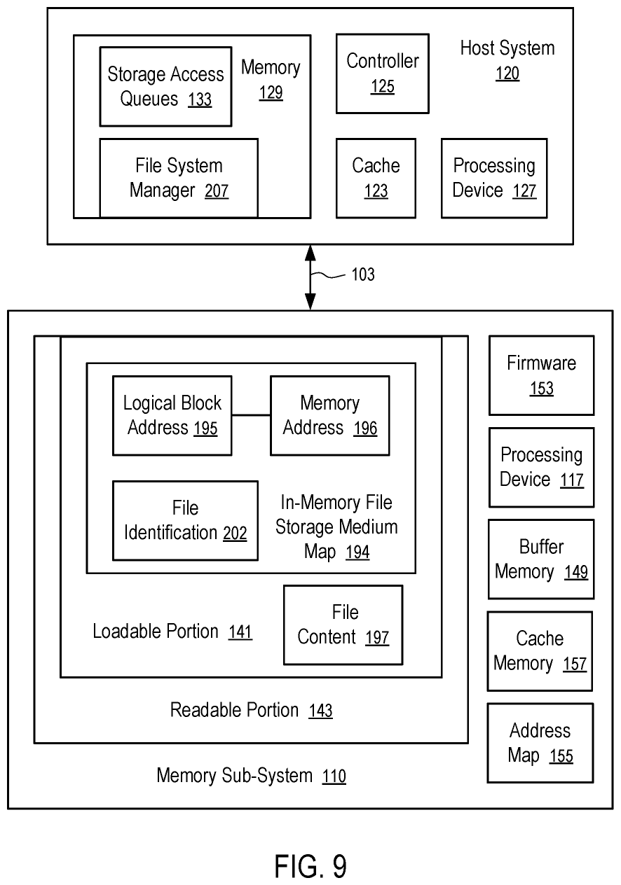

Optionally, the loadable portion 141 is configured in a readable portion 143 of the memory sub-system. Thus, the host system 120 can have both the option to access the file content 197 using the cache-coherent memory access protocol 145 and the memory addresses (e.g., 196) specified in the medium map 194 for the file identification 202, and the option to access the file content 197 using the storage protocol 145 and the logical block addresses (e.g., 195) specified in the medium map 194 for the file identification 202, as in FIG. 5 and FIG. 9.

FIG. 9 shows the storage management of files that are accessible both via a cache-coherent memory access protocol and via a storage access protocol according to one embodiment. For example, the technique of FIG. 6 can be implemented in the memory sub-system 110 of FIG. 9.

In FIG. 9, the host system 120 runs a file system manager 207 to mount an in-memory file system 201 that is at least in part in the loadable portion 141.

As in FIG. 7 and FIG. 8, the memory sub-system 110 in FIG. 9 can have a file storage manager 209, configured as part of firmware 153, to manage the in-memory file storage medium map 194 for the portion of the file system 201 configured in the loadable portion 141 (e.g., to store a file having an identification 202).

In FIG. 9, the loadable portion 141 is configured in the readable portion 143, as in FIG. 5. Thus, the host system 120 can read and write in the file having the identification 202 using the cache-coherent memory access protocol 145 and the memory addresses (e.g., 196) mapped to locations in the storage space of the file, and/or using the storage access protocol 147 and the logical block addresses (e.g., 195) mapped to locations in the storage space of the file.

For example, to access a location within the file having the file identification 202, the file system manager 207 can determine a memory address of the location based medium map 194. The processing device 127 of the host system 120 can execute a load instruction configured with the memory address to load data (e.g., as part of the file content 197) from the memory address in the loadable portion 141 over the connection 103. Similarly, the processing device 127 of the host system 120 can execute a store instruction configured with the memory address to store data (e.g., as part of the file content 197) from the memory address in the loadable portion 141 over the connection 103.

Alternatively, the host system 120 can enter read or write commands in the storage access queues 133 to request the memory sub-system 110 to retrieve the commands for execution using the storage access protocol 147. The file system manager 207 can determine, based medium map 194, a logical block address of a logical block containing the location within the file having the file identification 202. The read or write commands can be configured with the logical block address to read data from, or write data into, the logical block that contains the location to be access.

When the loadable portion 141 is implemented in a non-volatile memory (e.g., 139) that is slower than another memory (e.g., volatile random access memory 138), the memory sub-system 110 can allocate a portion of its fast memory (e.g., volatile random access memory 138) as a cache memory 157. Pages of the loadable portion 141 being accessed over the connection 103 using the cache-coherent memory access protocol 145 can be cached in the cache memory 157, as in FIG. 3 and FIG. 4.

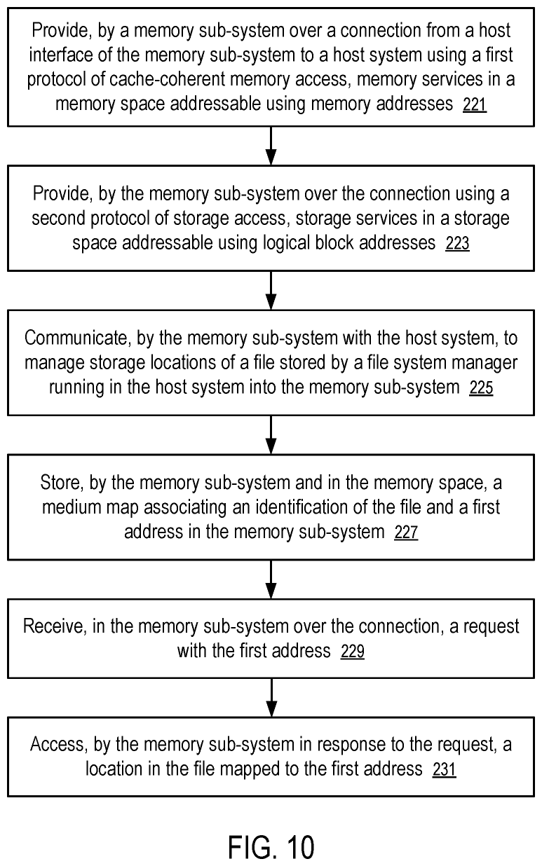

FIG. 10 shows a method to manage file storage locations using a memory sub-system according to one embodiment. For example, the method of FIG. 10 can be implemented in a memory sub-system 110 of FIG. 3, FIG. 7, FIG. 8, or FIG. 9 in computing systems of FIG. 1 and FIG. 2 using the techniques of FIG. 4, FIG. 5 and FIG. 6.

At block 221, a memory sub-system 110 provides, over a connection 103 from a host interface 113 of the memory sub-system 110 to a host system 120 using a first protocol 145 of cache-coherent memory access, memory services in a memory space (e.g., loadable portion 141) addressable using memory addresses (e.g., 163). The memory space represents a memory device attached by the memory sub-system 110 over the connection 103 to the host system 120. The memory device is accessible to the host system 120 over the connection using the first protocol 145 of cache-coherent memory access.

for example, the connection 103 can be configured in accordance with a standard of computer express link (CXL).

At block 223, the memory sub-system 110 provides, over the connection 103 using a second protocol 147 of storage access, storage services in a storage space (e.g., readable portion 143) addressable using logical block addresses (e.g., 183). The storage space represents a storage device attached by the memory sub-system 110 over the connection 103 to the host system 120. The storage device is accessible to the host system 120 over the connection using the second protocol 147 of storage access.

For example, the memory sub-system 110 can be configured to allocate a first portion of its volatile random access memory 138 as a cache memory 157, allocate a second portion of its volatile random access memory 138 as a buffer memory 149, and optionally allocate a third portion of its volatile random access memory 138 as part of the memory device. The majority of the memory device (e.g., loadable portion 141) can be configured in the non-volatile storage capacity 151 offered by a non-volatile memory 139 of the memory sub-system 110. The non-volatile memory 139 is slower than the volatile random access memory 138.

At block 225, the memory sub-system 110 communicates with the host system 120 to manage storage locations of a file (e.g., having content 197) that is stored by a file system manager 207 running in the host system 120 into the memory sub-system 110.

For example, the file system manager 207 can mount an in-memory file system 201 that is at least partially in the memory space (e.g., loadable portion 141) provided by the memory sub-system 110. Optionally, a portion of the file system 201 is in the memory 129 of the host system 120; and the file system manager 207 running in the host system 120 is configured to manage the file storage locations for the portion of the file system 201 that is in the memory 129 of the host system 120. The file system manager 207 can offload the task of managing file storage locations of files (e.g., content 197) stored in the memory sub-system 110.

For example, the file system manager 207 can mount a file system 201 in the storage space (e.g., readable portion 143) provided by the memory sub-system 110. The file system manager 207 can offload the task of managing file storage locations 215 of files having contents 205 stored in the memory sub-system 110.

In some implementations, the memory sub-system 110 is configured to implement the memory space (e.g., loadable portion 141) in the storage space (e.g., readable portion 143), as in FIG. 5 and FIG. 9. Thus, the file content 197 is stored and accessible in both the memory space (e.g., loadable portion 141) and the storage space (e.g., readable portion 143).

At block 227, the memory sub-system 110 stores, in the memory space (e.g., loadable portion 141), a medium map 194 associating an identification 202 of the file and a first address (e.g., logical block address 195 or memory address 196) in the memory sub-system 110.

For example, the medium map 194 can be configured to identify a set of memory addresses (e.g., 196) in the memory space (e.g., loadable portion 141) allocated to represent a file space of the file (e.g., storing file content 197). Locations in the file space are accessible via addressing the set of memory addresses (e.g., 196) over the connection 103 using the first protocol 145 of cache-coherent memory access.

Alternatively, or in combination, the medium map 194 can be configured to identify a set of logical block addresses (e.g., 195) used in the file system 201 to address logical blocks allocated to provide the file space.

For example, the file space of the file in the file system 201 is contiguous for an application using the file. A location in the file is defined in reference to the file.

When the file space is implemented in the memory space (e.g., loadable portion 141) provided by the memory sub-system 110, the file space can be mapped to a plurality of separate, disconnected memory regions in the memory space. The memory addresses (e.g., 196) identified by the medium map 194 define the mapping between a location in the file space and a corresponding memory location in the memory space at a memory address. The memory location is accessible to the host system 120 using the memory address over the connection 103 using the first protocol 145 of cache-coherent memory access without referencing the file and the file system 201.

Similarly, when the file space is implemented in the storage space (e.g., readable portion 141) provided by the memory sub-system 110, the file space can be mapped to a plurality of separate, non-contiguous logical blocks in the storage space. The logical block addresses (e.g., 195) identified by the medium map 194 identify the logical blocks and define the mapping between a location in the file space and a corresponding stored location in a logical block in the storage space specified by a logical block address and an offset within the logical block. The storage location is accessible to the host system 120 using the logical block address over the connection 103 using the second protocol 147 of storage access without referencing the file and the file system 201.

Optionally, the medium map 194 can be configured to provide a mapping between a set of logical block addresses (e.g., 195) for accessing locations in the file space and a set of memory addresses (196) for accessing locations in the file space. When the file space is implemented in the memory space (e.g., loadable portion 141) that is implemented in the storage space (e.g., readable portion 143), the logical block addresses (e.g., 195) can be used by the host system 120 over the connection 103 using the storage access protocol 147 to access the file space without referencing the file; and the memory addresses (e.g., 196) can be used by the host system 120 over the connection 103 using the cache-coherent memory access protocol 145 to access the file space without referencing the file.

Optionally, each of the plurality of separate memory regions in the memory space allocated for the file space has a size equal to a size of a logical block represented by a logical block address in the storage space. Alternatively, each of the plurality of separate memory regions in the memory space allocated for the file space has a size that is a fraction of the size of a logical block represented by a logical block address in the storage space.

The file system manager 207 running in the host system 120 can be configured to communicate with the file storage manager 209 running in the memory sub-system 110 via a message queue configured in the memory space (e.g., loadable portion 141) shared between the host system 120 and the memory sub-system 110.

For example, the file system manager 207 can use the message queue to offload, to the file storage manager 209, the task of managing the storage locations 215 of file contents 205 stored in the memory sub-system 110.

For example, the file storage manager 209 can allocate memory resources (e.g., from the memory space or the storage space) for a file (e.g., having content 197) stored in the memory sub-system 110 in response to a request from the file system manager 207 in the host system. The file storage manager 209 can update the medium map 194 to identify the allocated memory resources (e.g., memory regions, or logical blocks).

For example, the file system manager 207 can use the message queue to communicate with the file storage manager 209 to identify memory addresses (e.g., 196) or logical block addresses (e.g., 195) for accessing a location in a file space using the cache-coherent memory access protocol 145 or the storage access protocol 147.

Optionally, the file storage manager 209 can provide the medium map 194 in the memory space (e.g., loadable portion 141) for accessing by the host system 120 over the connection 103 using the cache-coherent memory access protocol 145.

At block 229, the memory sub-system 110 receives, over the connection 103, a request with the first address.

At block 231, the memory sub-system 110 accesses, in response to the request, a location in the file (e.g., file content 197) mapped to the first address.

For example, the request can be over the connection 103 in accordance with the first protocol 145 of cache-coherent memory access using a memory address (e.g., 196) and a load or store instruction, or in accordance with the second protocol 147 of storage access using a logical block address 195 and a read or write command.

In general, a memory sub-system 110 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a portion of a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 120 that is coupled to one or more memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 120 can include a processor chipset (e.g., processing device 127) and a software stack executed by the processor chipset. The processor chipset can include one or more cores, one or more caches (e.g., 123), a memory controller (e.g., controller 125) (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface 113. Examples of a physical host interface include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface can be used to transmit data between the host system 120 and the memory sub-system 110. The host system 120 can further utilize an NVM express (NVMe) interface to access components (e.g., memory devices 109) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The processing device 127 of the host system 120 can be, for example, a microprocessor, a central processing unit (CPU), a processing core of a processor, an execution unit, etc. In some instances, the controller 125 can be referred to as a memory controller, a memory management unit, and/or an initiator. In one example, the controller 125 controls the communications over a bus coupled between the host system 120 and the memory sub-system 110. In general, the controller 125 can send commands or requests to the memory sub-system 110 for desired access to memory devices 109, 107. The controller 125 can further include interface circuitry to communicate with the memory sub-system 110. The interface circuitry can convert responses received from the memory sub-system 110 into information for the host system 120.

The controller 125 of the host system 120 can communicate with the controller 115 of the memory sub-system 110 to perform operations such as reading data, writing data, or erasing data at the memory devices 109, 107 and other such operations. In some instances, the controller 125 is integrated within the same package of the processing device 127. In other instances, the controller 125 is separate from the package of the processing device 127. The controller 125 and/or the processing device 127 can include hardware such as one or more integrated circuits (ICs) and/or discrete components, a buffer memory, a cache memory, or a combination thereof. The controller 125 and/or the processing device 127 can be a microcontroller, special purpose logic circuitry (e.g., a field programmable gate array (FPGA), an application specific integrated circuit (ASIC), etc.), or another suitable processor.

The memory devices 109, 107 can include any combination of the different types of non-volatile memory components and/or volatile memory components. The volatile memory devices (e.g., memory device 107) can be, but are not limited to, random-access memory (RAM), such as dynamic random-access memory (DRAM) and synchronous dynamic random-access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 109 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 109 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells of the memory devices 109 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 109 can be based on any other type of non-volatile memory, such as read-only memory (ROM), phase change memory (PCM), self-selecting memory, other chalcogenide based memories, ferroelectric transistor random-access memory (FeTRAM), ferroelectric random-access memory (FeRAM), magneto random-access memory (MRAM), spin transfer torque (STT)-MRAM, conductive bridging RAM (CBRAM), resistive random-access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 109 to perform operations such as reading data, writing data, or erasing data at the memory devices 109 and other such operations (e.g., in response to commands scheduled on a command bus by controller 125). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the controller 115, in another embodiment of the present disclosure, a memory sub-system 110 does not include a controller 115, and can instead rely upon external control (e.g., provided by an external host, or by a processor or controller separate from the memory sub-system).

In general, the controller 115 can receive commands or operations from the host system 120 and can convert the commands or operations into instructions or appropriate commands to achieve the desired access to the memory devices 109. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 109. The controller 115 can further include host interface circuitry to communicate with the host system 120 via the physical host interface. The host interface circuitry can convert the commands received from the host system into command instructions to access the memory devices 109 as well as convert responses associated with the memory devices 109 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the controller 115 and decode the address to access the memory devices 109.

In some embodiments, the memory devices 109 include local media controllers 137 that operate in conjunction with the memory sub-system controller 115 to execute operations on one or more memory cells of the memory devices 109. An external controller (e.g., memory sub-system controller 115) can externally manage the memory device 109 (e.g., perform media management operations on the memory device 109). In some embodiments, a memory device 109 is a managed memory device, which is a raw memory device combined with a local controller (e.g., local media controller 137) for media management within the same memory device package. An example of a managed memory device is a managed NAND (MNAND) device.

In one embodiment, an example machine of a computer system within which a set of instructions, for causing the machine to perform any one or more of the methodologies discussed herein, can be executed. In some embodiments, the computer system can correspond to a host system (e.g., the host system 120 of FIG. 1) that includes, is coupled to, or utilizes a memory sub-system (e.g., the memory sub-system 110 of FIG. 1) or can be used to perform the operations discussed above (e.g., to execute instructions to perform operations corresponding to operations described with reference to FIG. 1). In alternative embodiments, the machine can be connected (e.g., networked) to other machines in a LAN, an intranet, an extranet, and/or the internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random-access memory (DRAM) such as synchronous DRAM (SDRAM) or Rambus DRAM (RDRAM), static random-access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and/or within the processing device during execution thereof by the computer system, the main memory and the processing device also constituting machine-readable storage media. The machine-readable medium, data storage system, and/or main memory can correspond to the memory sub-system 110 of FIG. 1.

In one embodiment, the instructions include instructions to implement functionality discussed above (e.g., the operations described with reference to FIG. 1). While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random-access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random-access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
providing, by a memory sub-system over a connection from a host interface of the memory sub-system to a host system using a first protocol of cache-coherent memory access, memory services in a memory space addressable using memory addresses;
providing, by the memory sub-system over the connection using a second protocol of storage access, storage services in a storage space addressable using logical block addresses;
communicating, by the memory sub-system with the host system, to manage storage locations of a file stored by a file system manager running in the host system into the memory sub-system;
storing, by the memory sub-system and in the memory space, a medium map associating an identification of the file and a first address in the memory sub-system;
receiving, in the memory sub-system over the connection, a request with the first address; and
accessing, by the memory sub-system in response to the request, a location in the file mapped to the first address.

2. The method of claim 1, wherein the connection is according to a standard of computer express link (CXL).

3. The method of claim 2, wherein the file is configured in a file system mounted, by the file system manager, at least in part in the memory space provided by the memory sub-system.

4. The method of claim 3, wherein the medium map is configured to identify a set of memory addresses in the memory space allocated to represent a file space of the file; and locations in the file space are accessible via addressing the set of memory addresses over the connection using the first protocol of cache-coherent memory access.

5. The method of claim 4, wherein the medium map is further configured to identify a set of logical block addresses used in the file system to address a set of logical blocks allocated to provide the file space.

6. The method of claim 5, wherein the medium map is further configured to provide a mapping between the set of logical block addresses and the set of memory addresses.

7. The method of claim 6, wherein the memory space is configured in the storage space; and the logical blocks of the file space are accessible via addressing the set of logical block addresses over the connection using the second protocol of storage access.

8. The method of claim 7, wherein the file space of the file is contiguous with reference to the file; the set of memory addresses are in a plurality of separate memory regions in the memory space; and the set of logical block addresses are not contiguous in the storage space.

9. The method of claim 8, wherein each of the plurality of separate memory regions has a size equal to a size of a logical block represented by a logical block address in the storage space.

10. The method of claim 9, wherein the communicating by the memory sub-system with the host system is via a message queue configured in the memory space.

11. A memory sub-system, comprising:
a host interface operable on a connection to a host system according to a storage access protocol and a cache-coherent memory access protocol;
a first memory configured to provide a non-volatile storage capacity of the memory sub-system, wherein at least a portion of the first memory is configured to implement a memory device attached via the connection to the host system;
a second memory faster than the first memory; and
a controller configured to manage storage locations of files of a file system mounted on the memory sub-system.

12. The memory sub-system of claim 11, wherein the controller is further configured to:
allocate memory resources for a file stored in the memory sub-system in response to a request from a file system manager in the host system.

13. The memory sub-system of claim 12, wherein the controller is further configured to manage a medium map configured to identify, for the file, first addresses usable by the host system to address the memory resources over the connection.

14. The memory sub-system of claim 13, wherein the first addresses includes memory addresses usable over the connection according to the cache-coherent memory access protocol, or logical block addresses usable over the connection according to the storage access protocol.

15. The memory sub-system of claim 14, wherein the file system is mounted at least in part in the memory device.

16. The memory sub-system of claim 15, wherein the portion of the first memory configured to implement the memory device is also configured to implement a storage device attached via the connection to the host system; the memory device is accessible to the host system over the connection using the cache-coherent memory access protocol; the storage device is accessible to the host system over the connection using the storage access protocol; and the connection is a computer express link connection.

17. A non-transitory computer storage medium storing instructions which, when executed in a computing system, cause the computing system to perform a method, comprising:
establishing a connection between a host system and a memory sub-system, the connection operable according to a storage access protocol and a cache-coherent memory access protocol;
attaching a first memory of the memory sub-system over the connection to the host system as a memory device accessible via the cache-coherent memory access protocol;
mounting a file system on the memory sub-system; and
configuring, via the memory device, the memory sub-system to manage storage locations of files in the file system.

18. The non-transitory computer storage medium of claim 17, wherein the method further comprises:
attaching the first memory over the connection to the host system as a storage device accessible via the storage access protocol;
wherein the files are accessible both in the memory device and the storage device.

19. The non-transitory computer storage medium of claim 18, wherein the method further comprises:
sharing, between the memory sub-system and the host system via the memory device, a medium map of the files;
wherein the medium map includes memory addresses usable to address locations in the files in the memory device, and logical block addresses usable to address blocks of the files in the storage device.

20. The non-transitory computer storage medium of claim 19, wherein the connection is a computer express link connection.
